(19) United States
(12) Patent Application Publication
(10) Pub. No.: US 2026/0057092 A1
(43) Pub. Date: Feb. 26, 2026

(54) Data Security System

(71) Applicant: Eftsure Pty Ltd, North Sydney (AU)

(72) Inventor: Mark Mervyn Chazan, St Ives, New South Wales (AU)

(21) Appl. No.: 18/814,257

(22) Filed: Aug. 23, 2024

Related U.S. Application Data
(63) Continuation of application No. 18/229,820, filed on Aug. 3, 2023, now abandoned.
Application No. 18/229,820 is a continuation of application No. 16/963,828, now abandoned.

(30) Foreign Application Priority Data
Jan. 23, 2018 (AU) 2018900216

(51) Int. Cl. G06F 21/62

(52) U.S. Cl. CPC G06F 21/6218

(57) ABSTRACT

The present invention relates to a system and method which facilitates automation of the interaction between suppliers and customers, particularly in a business to business context. A vendor management platform is provided which facilitates on boarding of vendor data for multiple suppliers, based on request by customers to on board suppliers. The platform may comprise a database which stores vendor data. Systems and processes are provided for verifying the vendor data, based on vendor database and also cross-checks with third party systems.

### FIELD OF THE INVENTION

The present invention relates to a vendor management system and method and, particularly, but not exclusively, to a vendor management system and method which facilitates the automation of the interaction between suppliers and customers.

### BACKGROUND OF THE INVENTION

When a customer takes on a new supplier, the customer requires certain information from the supplier. For example, the customer may require details of an account that they can use to pay the supplier, details of the supplier's address, identity, and other information. Information may be required for corporate responsibility requirements of the customer. Different customers may require different information from suppliers. There is currently no standardised way for businesses to onboard new suppliers and obtain the requisite information. Onboarding processes and systems are adhoc. There are a diverse range of difficult to manage systems and processes, therefore, for dealing with supplier/customer relationships and information. Each customer will generally have their own different approach.

Some customers may simply ask a supplier for a tax invoice and manually key those details into their accounting system. Others will send a PDF questionnaire or webform to be filled out electronically or by hand. Some will request suppliers to provide a copy of a bank statement to prove the account details are correct. Emails get forgotten, lost, sit in spam file folders or are sometimes forged. In some cases, customers will only accept bank details from a supplier if the customer independently calls the CFO or CEO's of the company. All these varying and adhoc processes are time consuming, an inefficient use of scarce and expensive company resources and are open to fraud and error.

From the supplier point of view, the varying requirements of different customers mean that each supplier may need to provide different information to each customer. Forms, web forms, etc. for each customer must be separately filled in, with varying information requirements. This is an imposition on suppliers resources and systems and is also prone to error. Furthermore, when a supplier changes their details—e.g. moves office, changes bank account etc., they need to again repeat the process of providing all the new details to all their customers and rely on the customers receiving and actioning the change.

### SUMMARY OF THE INVENTION

In accordance with a first aspect, the present invention provides a vendor management system, comprising a vendor management platform implemented by one or more processors, memory and an operating system supporting computer processes, a customer interface process arranged to receive, from a customer system, a request for on-boarding of one or more suppliers to the vendor management platform, a supplier interface process arranged to obtain, from a supplier system, vendor data relating to supplier information required by the customer, and an information management engine, arranged to populate one or more of a vendor database and customer form with the supplier information from the vendor data.

In an embodiment, in response to a request from a customer via their computing system, the vendor management system can obtain supplier information (in the form of requested vendor data) required by the customers so that they can have all the information that they require to interact with a supplier. This system advantageously relieves the customer of the burden of obtaining the information from the supplier (of whom they may have many).

In an embodiment, the vendor management system supports a vendor data database. The database may store vendor data received from many suppliers. In an embodiment, the information management engine may access the vendor data database, as well as or instead of contacting supplier systems, to determine whether it contains vendor data from suppliers required by the customer. In an embodiment, the information management engine may access other external sources to obtain vendor data or cross-reference data. In an embodiment, the information management engine may utilise algorithmic processes to determine the reliability and accuracy of data sources, including the vendor data database, the supplier systems and other external sources. Advantageously, over time, vendor data for many suppliers may be built up and stored in the vendor data database. The information management engine can therefore obtain reliable, verified, up to date customers' required data directly from the database in many instances for much of the required information.

In an embodiment, the vendor data management system allows access by multiple different customers. Customers may have various different requirements regarding the supplier information they want. In an embodiment, the system comprises a customer form engine which is arranged to enable a customer, via the customer interface, to select or create database fields and/or customer form fields designating vendor data required by the particular customer. The system therefore advantageously enables customisation of forms and/or database fields for customer requirements relating to supplier data, for multiple customers.

In an embodiment, where the system comprises a vendor data database, the system may be arranged to provide Vendor Master Files (VMFs) for each customer, for that customer's particular set of suppliers. The VMF may be uploaded to customer systems for use in the customer transacting with the suppliers. Alternatively, the VMF for each customer may be maintained remotely and hosted by the vendor management system on behalf of the customer.

In an embodiment, the management system further comprises an authentication engine. The authentication engine is arranged to implement authentication processes to automatically interface with third party systems to one or more of obtain vendor data and check the veracity of obtained vendor data.

In an embodiment, the authentication processes comprises a financial authentication process which is arranged to access a financial institution (FI) system to obtain vendor data in the form of vendor financial data from the FI system. In an embodiment, the financial authentication process is arranged to obtain secure access data from the supplier or supplier system to enable it to access a secure FI system and obtain the vendor financial data. Advantageously, financial data that may be required for a customer to pay a supplier may be obtained from a supplier and then cross-checked by accessing a FI of the supplier to confirm that the account information is correct e.g. BSB, account number, etc.

In an embodiment, the authentication processes comprise a company information process which is arranged to access one or more business register systems to obtain company business information. For example, in Australia, supplier business information may include an Australian Business Number (ABN). The company information authentication process, in an embodiment, is arranged to contact the Australian Business Register system and, using the supplier name, look up the ABN for the supplier. It can therefore verify the ABN. In an embodiment, the authentication engine is arranged to do a “three way check” on the financial information obtained from an FI and using the company information. For example, in Australia, the bank account name and account number are linked at the FI system. If the ABN is linked to the same name on the Australian Business Registry, then the authentication engine can confirm that this is the correct business name for the account, and when a Customer pays into the Supplier bank account number they can be sure they will be paying the Supplier with the correct ABN.

Authentication processes may be provided for connecting to other third party systems for verifying and/or obtaining other vendor data. E.g. Invoice processing systems process numerous company invoices on their behalf by scanning and interpreting the invoices which typically include ABN, and Bank account information. These systems therefore are also a source of data that can be leveraged by the authentication engine to cross match the data with the other sources to confirm their veracity.

Authentication processes may be provided for by cross referencing the data supplied by the supplier to the data provided by multiple customers of the supplier. Where supplier data matches data provided by multiple customers, the level of confidence in the accuracy of the data is significantly improved.

In embodiments, the management system has the advantage that not only does it enable customers to easily onboard suppliers, it also carries out automated checks of publicly available and/or secure systems to verify supplier information. This obviates the need for the customer to make these checks and therefore lifts a considerable burden off the customer resources. In any case, many customers are not in a position to make these verification checks.

For the supplier, in embodiments the system has the advantage that the supplier may need to provide most of their information only once and the information will be suitable for a plurality of customers. This saves the supplier having to fill in as many different forms as there are customers, when they wish to engage in business. Being the subject of the verification checks implemented by the system also advantageously demonstrates the bonafides of the supplier and enables the suppliers to represent themselves as an “approved” supplier who has undergone verification (by the management system).

In an embodiment, the management system further comprises a maintenance engine, arranged to implement maintenance processes for maintaining currency of vendor data. In an embodiment, the management system may be arranged, via the supplier interface to receive supplier “feeds” updating vendor data e.g. changing of bank account details. These details may then be used to update the VMF for the customers. In embodiments, maintenance processes may be arranged to interface with third party systems to periodically check for changes to vendor data. For example, maintenance processes may establish dates for expiry of certificates (e.g. insurance policies) and automatically check systems to see if the certificates/policies are updated prior to expiry. Other checks may be made.

In an embodiment, the management system further comprises a rating engine to automatically facilitate application of ratings to suppliers. In an embodiment, the rating engine may monitor transactions and/or payments by customers to the Supplier via the management system and use the transaction data obtained in applying a rating to a supplier.

In an embodiment, the management system further comprises a supplier search engine, and supplier search processes, enabling users to search for suppliers that may already be registered with the system. Searching may be by way of any criteria. This enables customers, who are looking for suppliers to obtain suppliers who have been verified and/or rated by the system.

In accordance with a second aspect, the present invention provides a vendor management method, comprising the steps of receiving, by a vendor management platform, via a customer interface, a request for on-boarding of one or more suppliers, obtaining, via a supplier interface, vendor data relating to supplier information required by the customer, and populating one or more of a customer form and vendor database with the obtained vendor data.

In accordance with a third aspect, the present invention provides a computer program, comprising instructions for controlling a computer to implement a vendor management system in accordance with the first aspect of the invention.

In accordance with a fourth aspect, the present invention provides a computer readable medium, providing a computer program in accordance with the third aspect of the invention.

In accordance with a fifth aspect, the present invention provides a data signal, comprising a computer program in accordance with the third aspect of the invention.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic block diagram of a system in accordance with an embodiment of the present invention;

FIG. 2 is a schematic block diagram of a computing system which may be utilised in an embodiment of the present invention;

FIG. 3 is a flow diagram illustrating a supplier on-boarding process in accordance with an embodiment of the present invention;

FIGS. 4 through 12 are schematic screen snaps illustrating operation of an embodiment of the present invention;

FIG. 13 is a flow diagram illustrating a “three-way check” process in accordance with an embodiment of the invention, and

FIGS. 14 through 25 are further schematic screen snaps illustrating operation of embodiments of the invention.

### DETAILED DESCRIPTION OF EMBODIMENTS

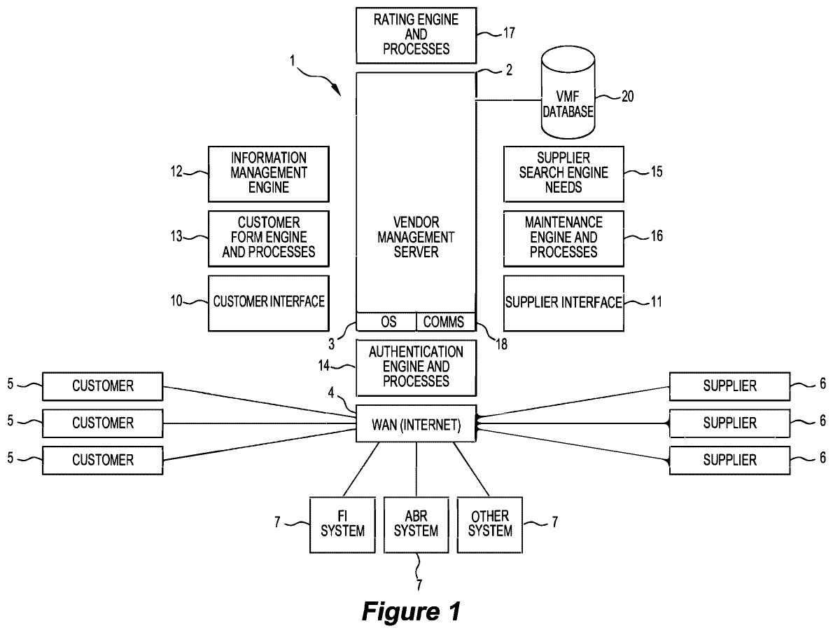

FIG. 1 schematically illustrates a vendor management system, generally designated by reference numeral 1, in accordance with an embodiment. In this example, the vendor management system is implemented by a server 2 (which may be supported in the Cloud).

The server 2 comprises one or more processors, memory and an operating system 3 which supports various computer processes. The system and processes implement a vendor management platform.

The vendor management system 1 is arranged for communications via a network 4 with customer systems 5. The network 4 may be any network, and in this example is a wide area network for (WAN) communications, such as the Internet.

Note that any network communications may be utilised, and the invention is not limited to communications via the Internet.

Each customer system 5 may comprise an appropriate computing system hosted by or on behalf of a customer who wishes to engage with suppliers. Each customer computing system 5 may comprise processors, memory and an appropriate operating system for running computer processes. It may also comprise one or more browser applications for communicating over the Internet with web pages which may be served by the vendor management system 1.

In FIG. 1, only three customer computing systems are shown. It will be appreciated that this is representative only of what may be many more customer computer systems able to interact with the system 1. The embodiment is not limited to three customer computing systems.

The system 1 is also arranged to communicate with supplier computing systems 6. Supplier computing systems 6, as with the customer computing systems 5, may comprise any appropriate computing system. Each supplier computing system 6 may comprise processor(s), memory and operating systems running computer processes including a browser or similar type application for receiving web pages or otherwise communicating with vendor management server 2 via the WAN 4. There may be many more supplier systems than the three shown in the diagram, and the embodiment is not limited to three only.

The computer processes supported by server 2 comprise a customer interface process 10 which is arranged to receive, from a customer system 5, a request for on-boarding of one or more suppliers to the vendor management platform. The processes also comprise a supplier interface 11 arranged to obtain, from a supplier system 6, vendor data relating to supplier information required by the customer.

The system 1 also comprises a vendor data database 20 which may store information on a plurality of suppliers in the form of a vendor master file (VMF).

The processes also comprise an information management engine 12, which is arranged to populate one or more of the VMF database 20, customer form or customer system 5 with the supplier information.

The system 1 is also arranged to communicate via WAN 4 with third party systems 7. These may include a system of a financial institution (FI) (e.g. bank), system of a business registry (e.g. Australian Business Registry) and any other third party systems that the system 1 may require access to in order to check and confirm or obtain supplier information. The third party systems 7 may comprise appropriate hardware and software, operating systems and computer processes to implement the required functionality and also to enable communications with system 1.

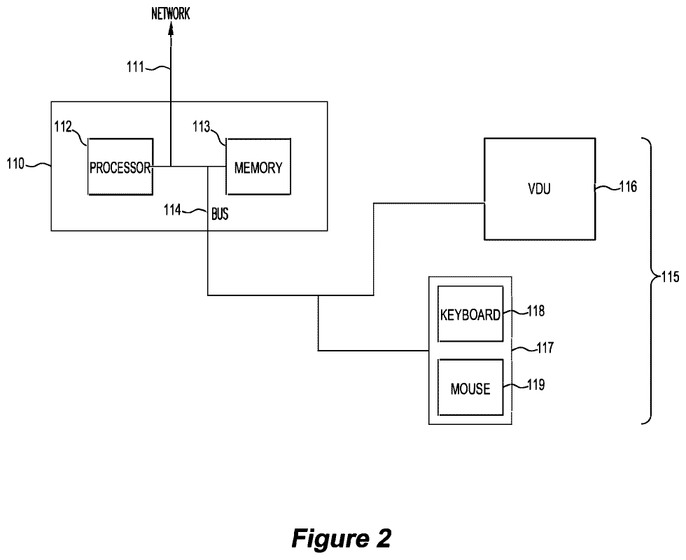

FIG. 2 is an example block diagram of a computing system which may be utilised in implementation of embodiments of the present invention. For example, it may be utilised in the embodiment of FIG. 1 as the vendor management system.

The supplier system, customer system and third party system of FIG. 1 may be based on similar arrangements described in relation to FIG. 2.

The illustrated computing system comprises a computer which includes a processor 112 and memory 113. The processor 112 is arranged to process programme instructions and data in a known manner. Memory 113 is arranged to store programme instructions and data also in a known manner. Processor 112 may constitute one or more processing means, such as integrated circuit processors. The memory 113 may comprise any known memory architecture and may include hard disk, IC memory (ROM, PROM, RAM, etc.), floppy disks and other types of additional memory such as CD ROM, and any other type of memory.

A BUS 114 is provided for communication between the processor 112 and memory 113 and also communication with external components. In this case the external components include a user interface 115. The user interface 115 includes a visual display unit 116 for displaying information to a user. The VDU 116 may display information in graphical format or any other format depending upon the programme instructions being processed by processor 112.

The user interface 115 also includes user input means 117 which in this example include a keyboard 118 (which in this example may be a standard QWERTY keyboard) and a mouse 119. The mouse 119 may be used to manipulate a graphical user interface (GUI) if a GUI is provided by software running on the computer. A network connection 111 is also provided for connecting to a network which may include a communication network 4 and other computers/computing systems.

The computing system of FIG. 2 may be implemented by any known type of computing hardware such as, for example, a PC, by a number of networked PCs if required to implement a system of this embodiment, by a “mainframe architecture” including a remote computer and user workstations connected to the remote computer, by a client-server architecture, including a client computer accessing a server computer over a network, or by any other computing architecture.

Parts of the system or the entirety of the system may be housed in the “cloud”. This embodiment of the present invention is implemented by appropriate software providing instructions for operation of the computing system hardware to implement the apparatus of the embodiment and implement the method of the embodiment.

Part of the system or the entire computer system may be portable, and may be implemented, for example, by a laptop or tablet computer, smartphone or other portable device.

The computing system is provided with an operating system and various computer processes to implement functionality. The computer processes may be implemented as separate modules, which may share common foundations such as routines and sub-routines. The computer processes may be implemented in any suitable way and are not limited to separate modules. Any software/hardware architecture that implements the functionality may be utilised. The computing system 110 may be implemented as a server computing system, or utilising computer resources in the cloud, or any other computer resources. In this embodiment, the system 1 is implemented utilising cloud resources.

Referring again to FIG. 1, the vendor management system 1 is therefore arranged to obtain supplier information (in the form of vendor data requested by the system) required by customers so they have all the information that they require to interact with the supplier. As well as obtaining information required by a customer, the system is also able to actively verify the information and maintain it, as will be described in more detail below.

The processes supported by the system 1 include a customer form engine and processes 13. The customer form engine and processes 13 enable a customer, via the customer interface 10 and their system 5 to select or create database fields or form fields to receive supplier's vendor data, as required by the customer. Many fields (vendor data) will be common for many customers. Where there are common fields they can be presented by the customer form engine 13 to the customer systems 5. Where bespoke items are required by the customer, they can select or create fields.

Via the supplier interface 11, the supplier can access customer requirements implemented by the customer form engine 13 and enter the details via the supplier system 6.

The information management engine 12, is arranged to pre populate customer forms/databases from vendor data that it may already have (in the VMF database 20, for example). Suppliers may therefore not need to laboriously fill out individual forms for each separate customer, with the same information. Where customer forms have vendor data requirements in common (of which there will be many), if a supplier has filled in one form the information management engine 12 will automatically populate customer forms/databases with the common information. The supplier merely needs to update the bespoke information that may be required for particular customers. This makes the on-boarding process much simpler for suppliers.

The system 1 computer processes also comprise an authentication engine and authentication processes 14. The authentication processes are arranged to automatically access third party computing systems 7 to either obtain required vendor data or check already obtained vendor data against data available from the further system 7. This independent verification process provides a high degree of certainty regarding supplier information, particularly financial information (e.g. bank accounts). Customers can therefore be assured that they have the correct financial information, for example, in order to pay the suppliers, and that the suppliers are who they say they are.

Maintenance engine and processes 16 allow maintenance of the vendor data. If a supplier changes their vendor data (e.g. name, financial information, etc.) the maintenance engine can obtain the updated vendor data and update the VMF 20 (and update/alert customers).

Supplier search engine 15 enables the vendor management system 1 to search for suppliers that are already on the vendor data base 20 or are not yet on-boarded. Data “feeds” from suppliers directly to customers may provide updates and information to customers.

The processes also comprise a rating engine and processes 17, which enable suppliers to be allocated a rating. The rating engine is arranged to monitor transactions via the management system and use the transaction data obtained to facilitate application of a rating to a supplier.

The application of the system and method of this embodiment will now be illustrated with reference to example operation of the vendor management system 1.

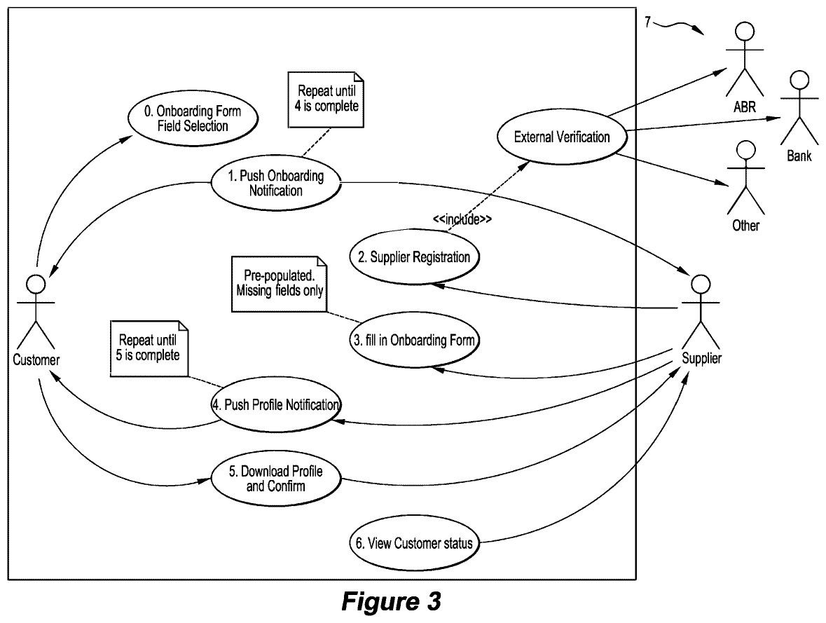

FIG. 3 is a flow diagram which gives an overview of a supplier on-boarding process utilising the system 1, from customer 5 forms selection (step 0) through to supplier on-boarding for that customer (step 5).

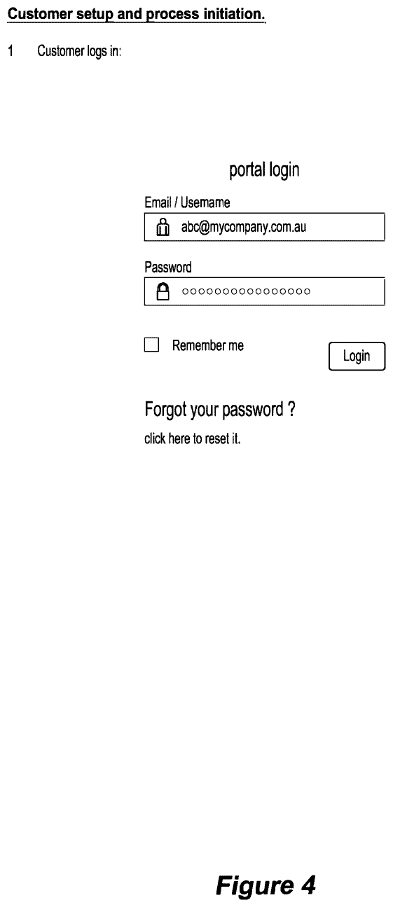

Referring to FIG. 3, at Step 0, a customer who wishes to on-board a supplier (or suppliers) accesses the system 1 via the customer system 5, browser and the customer interface 10 generated by the vendor management server 2. The customer interface process 10 uploads to the customer system 5 browser a “login” page (FIG. 4). If a customer is registered with the system, they merely enter their username and password to access the system 1. If a customer is not, they undertake a registration process (not shown).

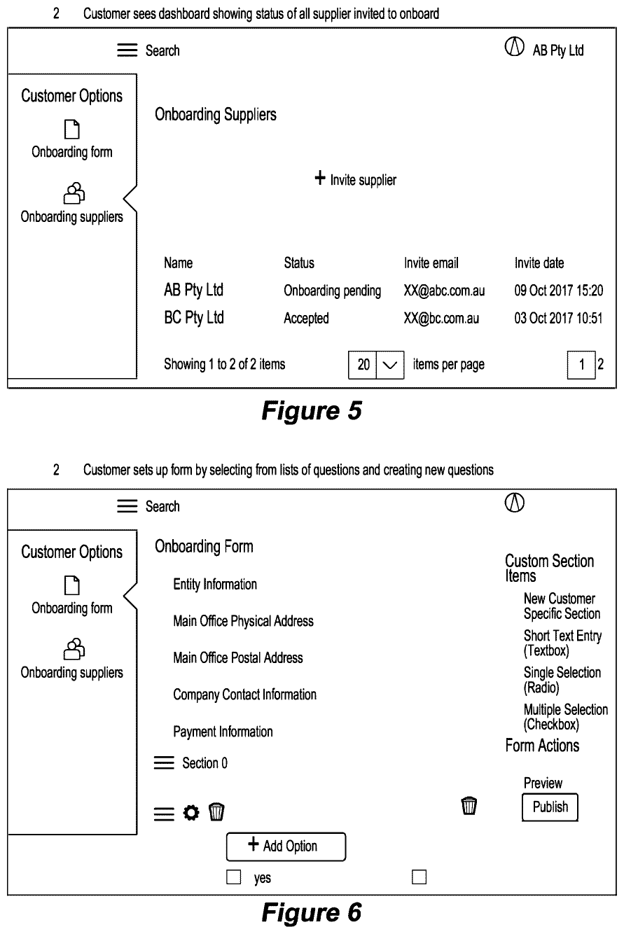

On entry into the system, the customer interface 10 presents the customer with a dashboard showing a status of all the suppliers they may have invited on-board already (see FIG. 5). The FIG. 5 examples show that one supplier's on-boarding is pending and the other supplier's on-boarding has been accepted. The customer can fast track the status of suppliers that they have invited to supply them.

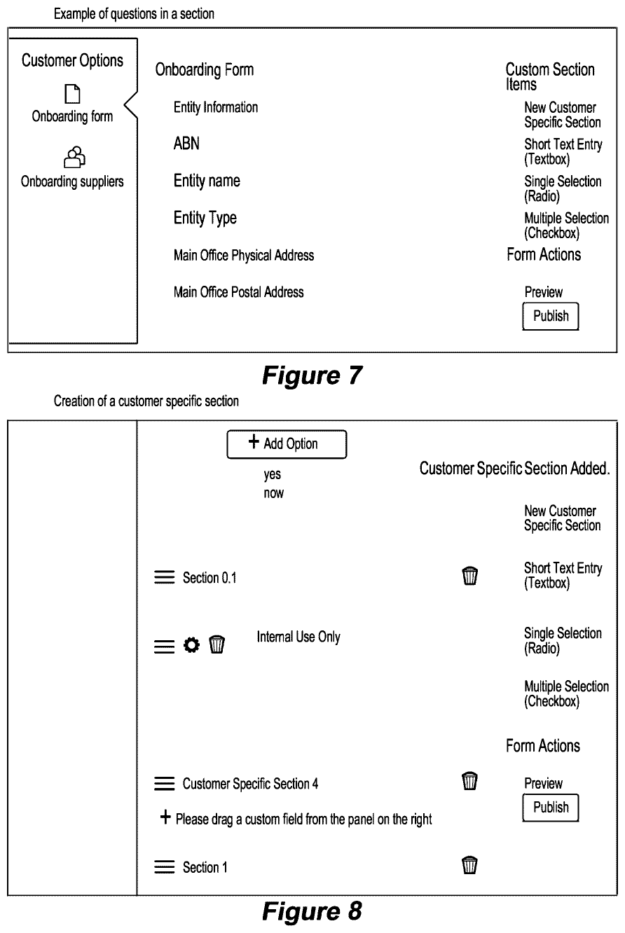

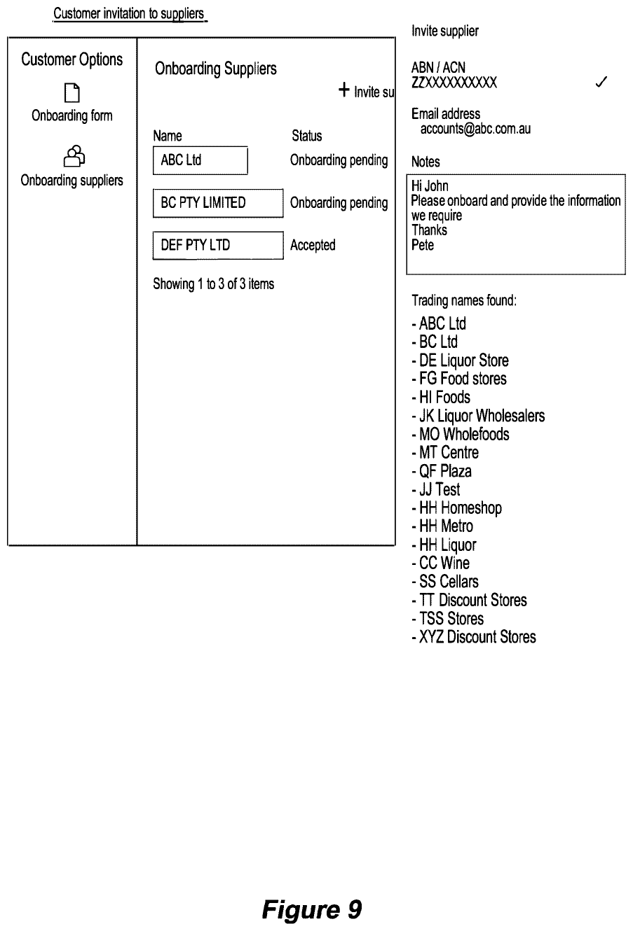

The customer form engine and processes 13 of the system 1 are arranged to enable a customer to select and create form fields for forms to ask suppliers questions, for on-boarding purposes. FIG. 6 illustrates an interface generated by the customer form engine and processes 13 and customer interface 10 which enables a customer to set up a form by selecting from a list of questions and creating new questions. The customer form engine and processes 13 generate a number of standard questions that are commonly asked by most customers e.g. name, address, email, bank account information etc. as well as a number of additional questions that some but not all customers will require from their suppliers, such as insurance details, compliance certificates and others. FIG. 7 shows examples of some questions in a section of the form.

The customer initially sets up the supplier form by simply selecting all the questions the customer requires a supplier to answer.

If there are customer specific questions which the customer form engine and processes 13 do not have in their list, the customer may simply add whatever questions required through a simple drag and drop process. This may include all common types of question fields, such as Yes/No check boxes, lists of choices, file uploads or simple text fields. They can also add fields that are for internal use only. FIG. 8 shows a customer interface generated for creation of a customer specific section.

The customer form engine and processes 13 enable the customer to preview the form to confirm that it is the form they wish to send to their supplier(s). Once happy with the form, the customer operates the system 1 via the interface 10 to send out invitations to suppliers (step 1 of FIG. 3).

In order to enable the system 1 to send the invites to the suppliers, a customer can enter the ABN (not required in some embodiments), email (and potentially the mobile number) of the supplier being on-boarded. Potentially or alternatively, the system 1, via the authentication engine and processes 14 can access external systems 7 to do real time lookup of information such as (in Australia, for example) ABN, and display all relevant information on customer interface 10. The information may be located from various external sources, e.g. the Australian Business Register, White Pages™, Google™, etc. Further, the information management engine 12 may detect that information on this particular supplier is already stored in the VMF 20 (perhaps because other customers have asked for on-boarding of this particular supplier(s)). In which case information can be obtained from the VMF 20.

There is also the option of the customer uploading to the system 1 via the customer interface 10, a file containing lists of suppliers and their details, whom the client wishes to on-board to the vendor management system 1.

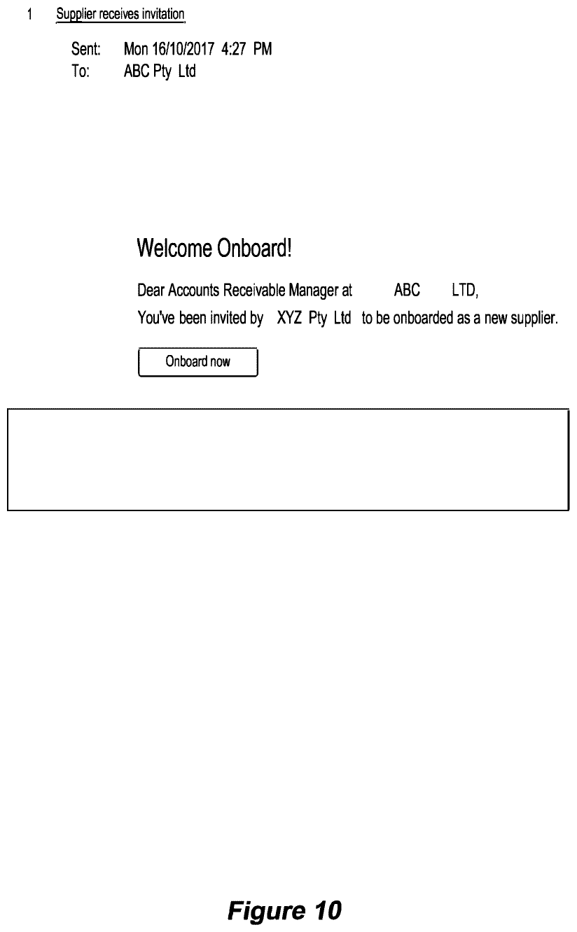

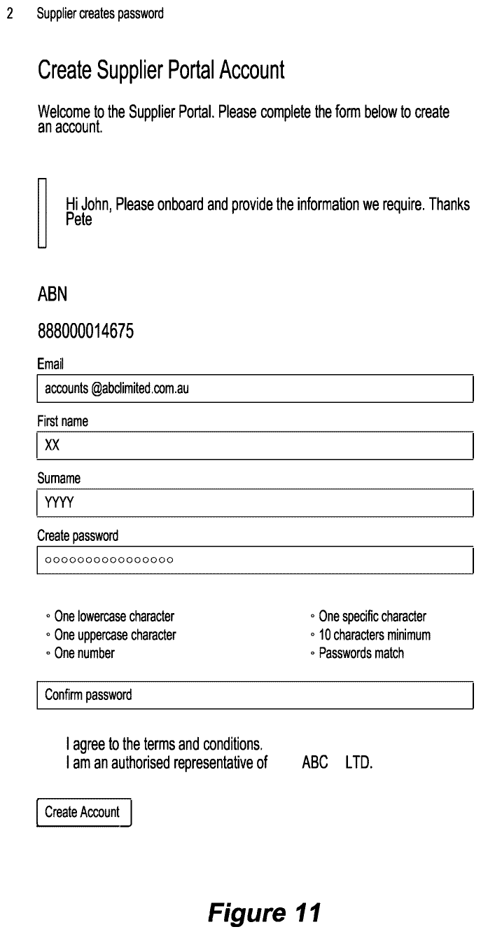

The customer clicks the invite button and the system then sends the email invite to the supplier. The supplier receives the invitation on their system 6 via email (or other mechanisms e.g. phone text message). See FIG. 10. The supplier clicks the “on-board now” button and their system 6 then accesses the system 1 via the supplier system 6 and supplier interface 11. See FIG. 11 for the view presented to the supplier system 6 via their browser. The supplier creates a password and if required enters the one time password (Step 2, FIG. 3).

Via the supplier interface 11, supplier system 6 is presented with the customer form, with all the pre-filled information that the vendor management system 1 has already obtained. This may have been obtained from external sources via authentication engine and processes 14, or from the VMF database 20 (where this particular supplier has already interacted with the vendor management system 1), or from information that the customer uploaded. It is a significant advantage for suppliers to on-board to the vendor management system, as it standardises the process for suppliers, it means they don't have to laboriously fill in different forms for different customers, commencing from the start each time. Once they have been on the vendor management system 1, it is likely they will only need to fill in small amounts of information as a majority of their information in common to customers will already be stored in the VMF 20 and/or obtained automatically by the system via the authentication engine and processes 14.

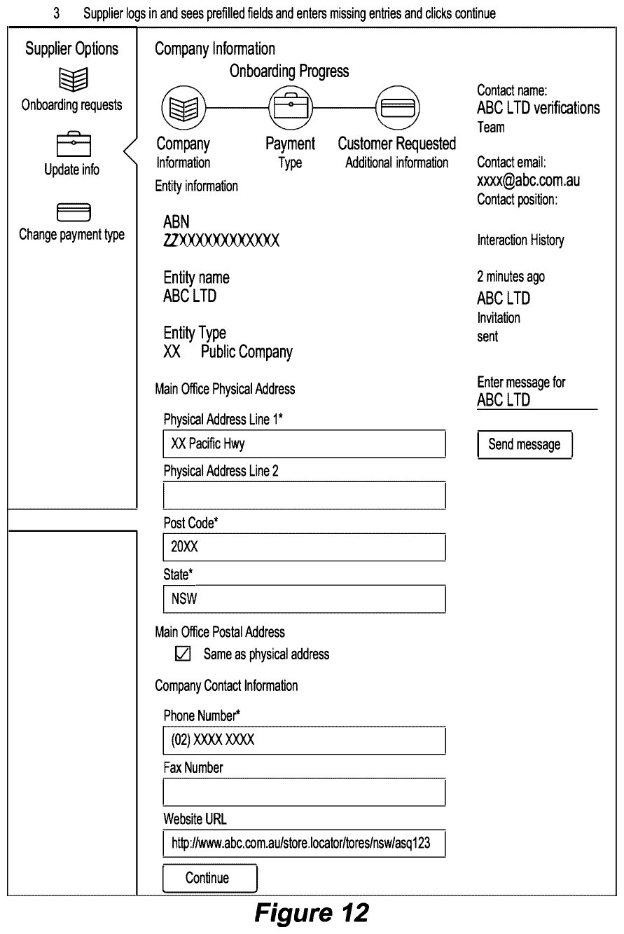

The supplier fills in any of the information that is missing in the customer form (see FIG. 12). They also check that the details are correct (Step 3, FIG. 3).

One of the important items of information required by customers is supplier financial information. For example, the customer will require account information so that they are able to pay a supplier. It is important that this account information is correct and associated with the name of the supplier that the customer is aware of to avoid errors and fraud. In this embodiment of the invention, the authentication engine and processes of the system 1 are arranged to carry out a “three-way check” to provide a high level of verification of the supplier financial information.

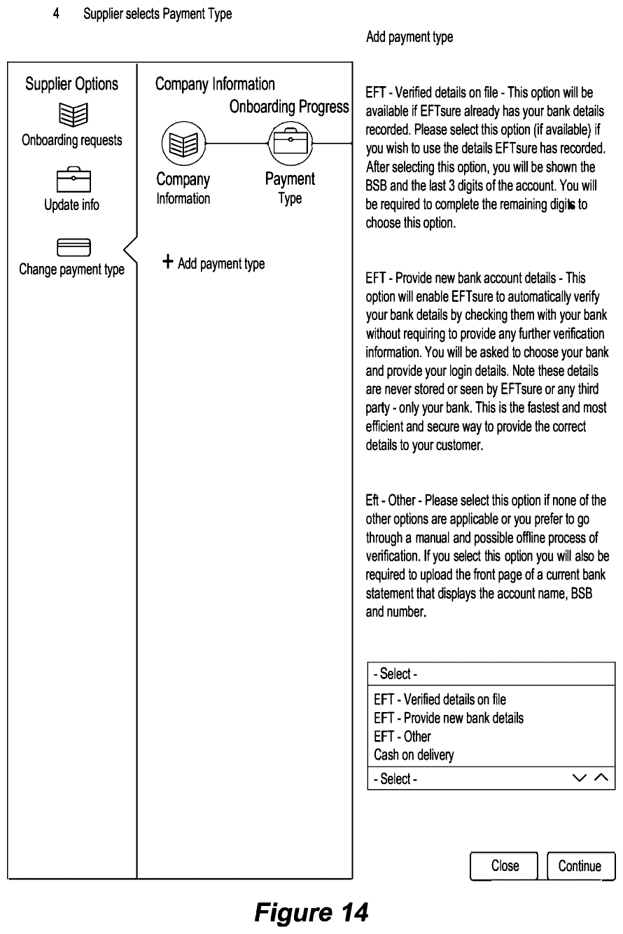

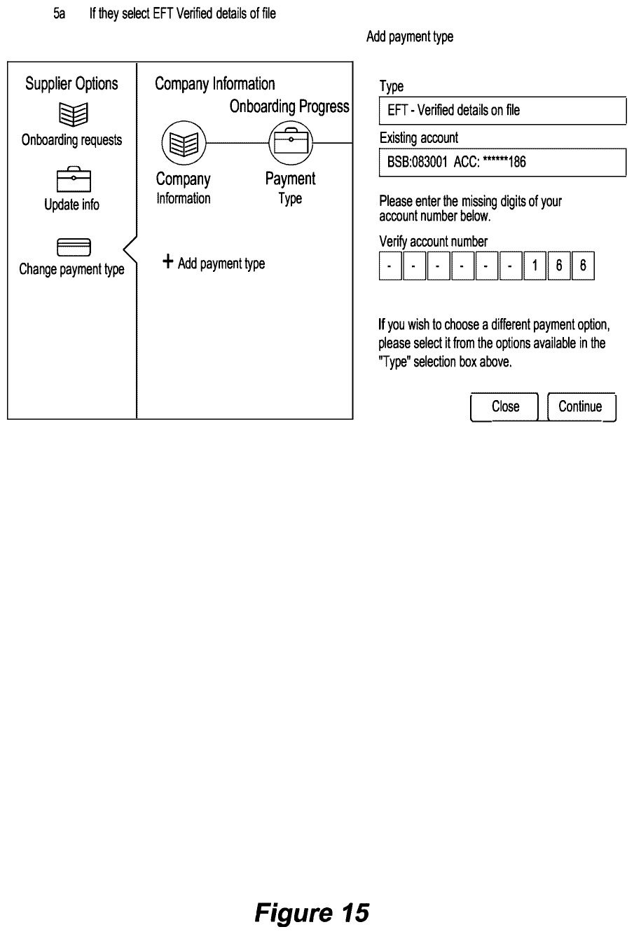

During the supplier on-boarding process (Step 3 of FIG. 3) the supplier checks the basic details that have been populated and/or filled in by the supplier, and then gets asked to choose a payment type (FIG. 14). There are a number of types to choose from e.g. Cash On Delivery (COD). If the system 1 already has the details verified they can choose that option. Ie the system may have already independently verified the details through cross matching it from data provided by any or all of multiple customers, financial institutions and other trusted sources. If not, the supplier may choose a real time verification process or simply enter the information and upload a document (e.g. a bank statement or an invoice on their letterhead). FIG. 15 illustrates the screen presented to the supplier if they already have verified details on file.

If the supplier chooses COD or simply chooses to enter the details and upload a document, the system 1 records this information for passing onto the customer but depending on the arrangement with the customer, either doesn't verify it or the system produces a notification to the verification team that perform a verification via other means-see below. If the supplier is already known to or cross verified by the system 1, the supplier will be displayed the last 3 digits of their account number and asked to complete the remaining digits (FIG. 15).

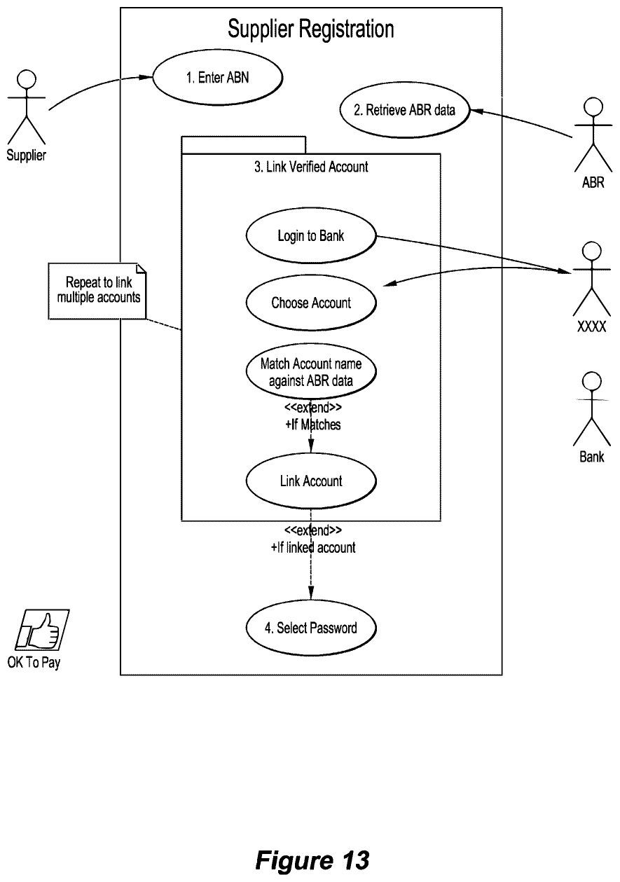

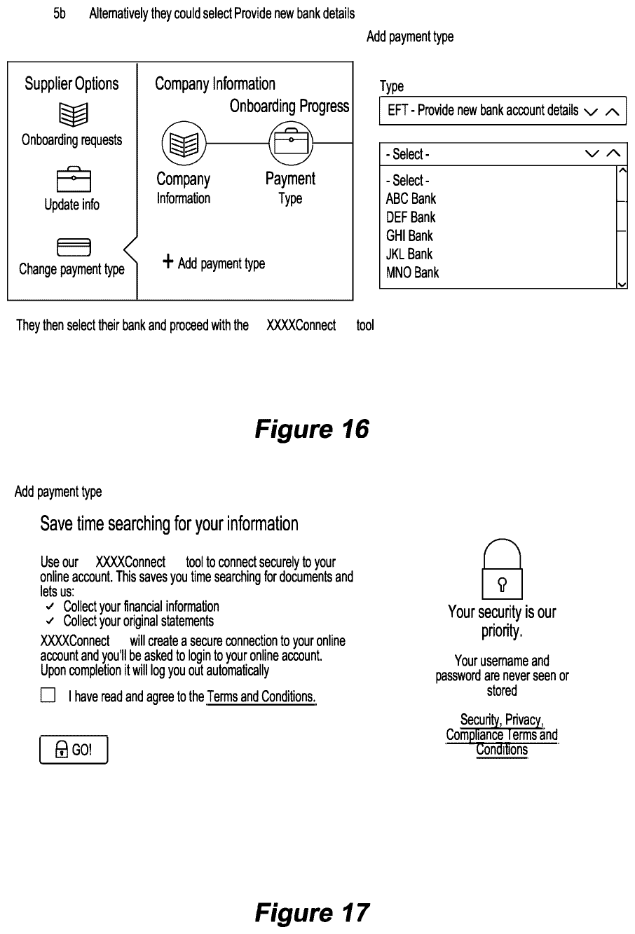

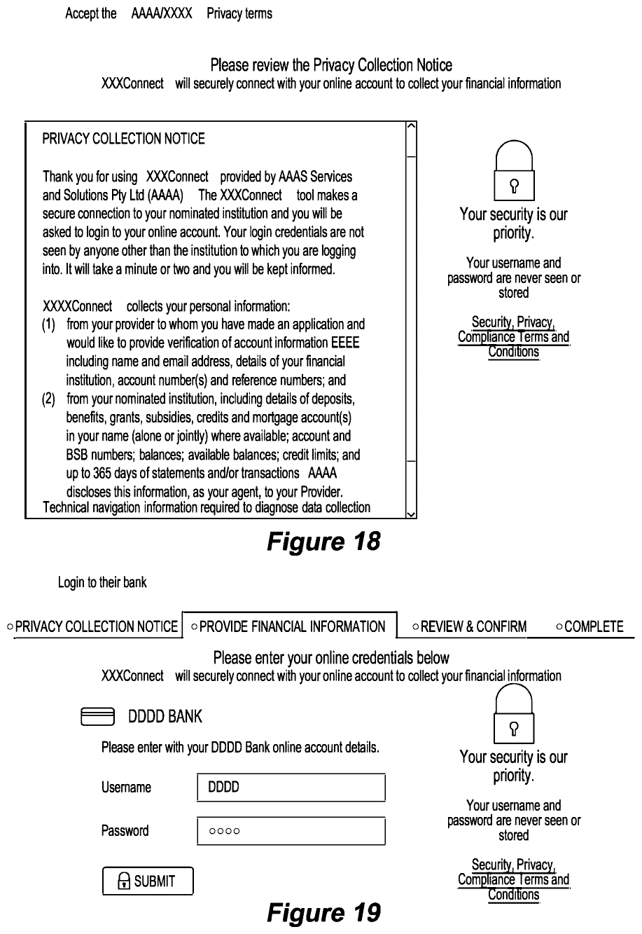

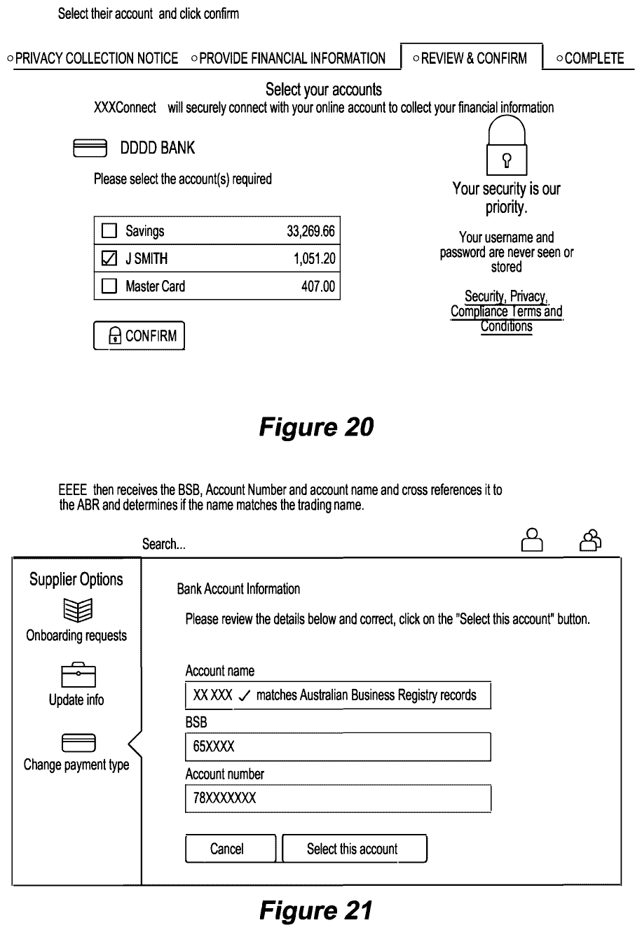

If the supplier is not known to the system 1, or chooses a real time verification process, the system 1 implements the three-way check via the authentication engine and processes 14. See FIG. 13 for the steps in the three-way check process. See also FIGS. 16 through 21.

Referring to FIG. 13, Step 1, the supplier enters its ABN (if this is not already saved by the system 1). The authentication engine accesses the ABR system (in Australia, it could be another business registration system in other jurisdictions) and retrieves the ABR data and confirms the ABN (Step 2). This also confirms the name of the supplier (which should be matched with the name the supplier has confirmed via the system 1). The system has built in “fuzzy logic” to ensure minor mismatches do not produce “false positives” e.g. Ltd instead of “Limited” or “&” instead of “and”. The matching is based on a match percentage which is determined through various weighted criteria.

The authentication engine and processes 14 then implement a secure process to access the FI system 7 of the FI provided by the supplier. The supplier is asked to choose from a list of supported banks following which the system generates a screen (see FIG. 13) asking them to provide their secure details to log in to their FI system. They enter their banking credentials. These are not seen by, stored or even passed through the vendor management system 1. The authentication engine and processes also never store the secure identity information. It merely uses them to send to the relevant FI and retrieve directly from the FI system that the account name and BSB and account number (or whatever financial information is required, depending on jurisdiction).

The authentication engine and processes 14 then carry out the three-way check. The financial institution has provided the confirmation and linkage of the bank account name to the account number. This account name is then compared to the trading names that the ABN look up provides. If the bank account name is located in the list of trading names in the ABR, then the system 1 has verified that if the customer pays into the retrieved bank account number, they will definitely be paying the supplier with the given ABN. This three-way check between ABN, bank account name and bank account number is a very secure verification, and provides the highest level of verification of a supplier's banking details. There is also no typing involved when entering the account number, therefore reducing the risk of errors.

Similar checks can be performed to match ABN, Account Name and Australia's New Payment Platform's (NPP) “PayId”.

The supplier may provide multiple bank accounts if required, by repeating the above process.

Where the system produces a notification to a verification team, the following verification process may be applied:

The authorised team member logs in to the system to process all verification requests.

The system presents the team member with an “independent” contact phone number for the organisation. The number needs to be independently obtained versus relying on the number entered by the Supplier in the form in order to be trusted.

The system determines the above independent number by performing automated external “chained” lookups off multiple systems. EG it will look up the ABN on the ABR, which may indicate the address of the organisation. The system may use the Address together with the name to interact with a 3rd party API e.g. google Maps or Sensis to determine the address that Google has for the organisation. If the address provided by the ABR is within a given radius provided by google, that can be used as an address in the White Pages to get a phone number for the organisation.

That phone number can then be presented to the team member who can use it to call the organisation to ask for the accounts department and can ask the person responding to confirm the bank information.

The team member will record all the meta data about the call(s) such as the time, who they spoke to etc. into the system and then mark the record as “verified”, “incorrect” or unable to be confirmed.

This information gets added to the information that the customer receives and saves the customer the time, effort and cost of attempting to verify the data themselves.

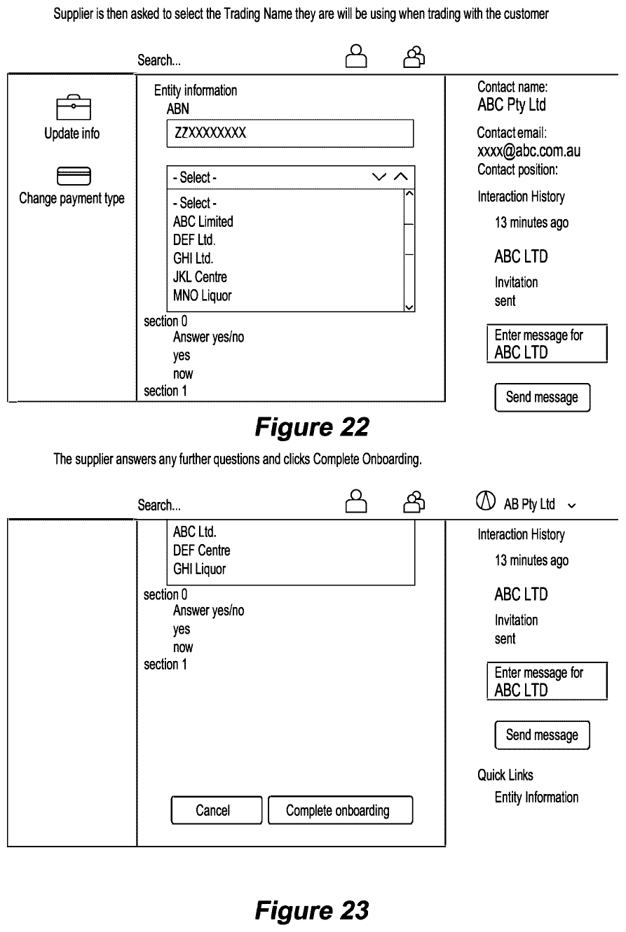

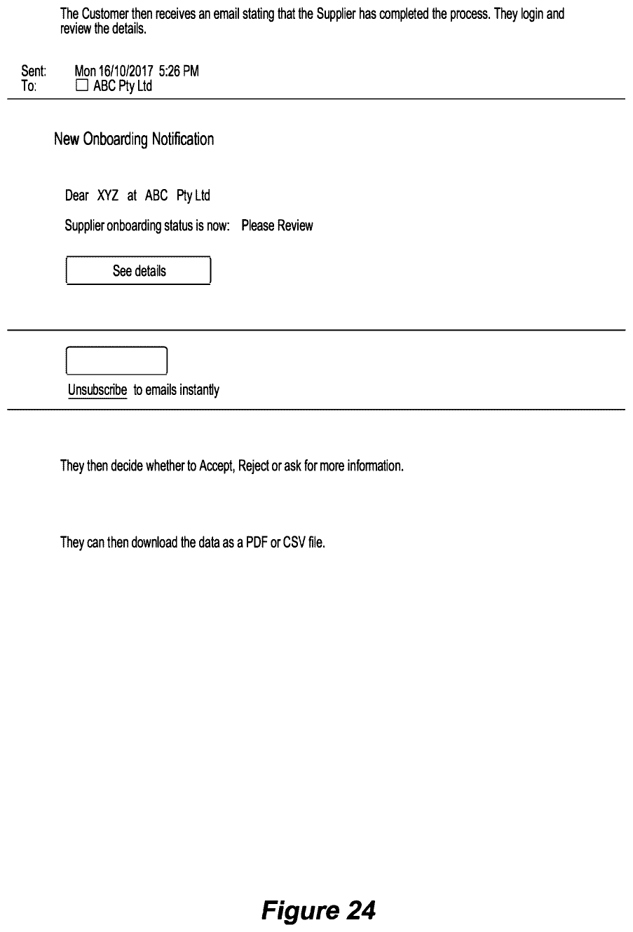

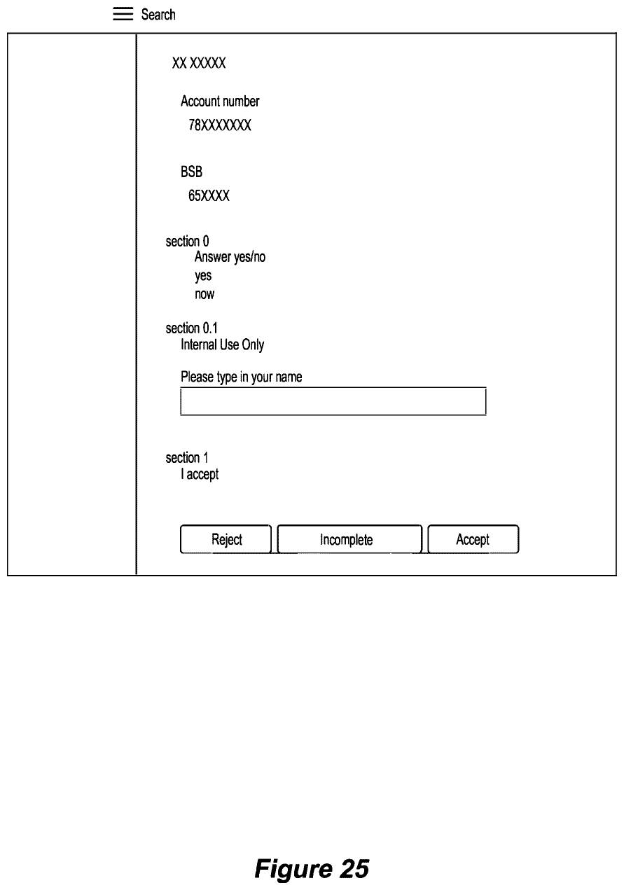

Once the authentication process is completed, the supplier can select a trading name that they will use when trading with the customer FIG. 22. The supplier is then asked to complete any further customer specific questions (FIG. 23) the customer may have added to the on-boarding form during customer setup. Once complete the supplier clicks submit and then the customer receives an email stating that the supplier has completed the process (FIG. 24).

The customer may access the system 1 via the customer interface 10, review all the details and decide whether to accept or reject the on-boarding or request further information. Whichever option is chosen, an email is sent to the supplier to inform them of their status.

Both supplier and customer can access the system 1 at any time to see what the status is of all their current in progress on-boarding or on-boarding requests. Furthermore each communication and status change is logged in the system and both parties can send and track messages in the system to communicate between them.

Once a supplier has completed the on-boarding and the customer is satisfied with the supplier's on-boarding information, they can download/save/print information on a PDF or export the supplier's information in a CSV format for uploading into their accounting system.

In an embodiment, the system is integrated directly into various common ERP and accounting packages to automatically populate the system.

In an embodiment, the exported data is signed with a private key so that the Customer can check the data originated from the system and hasn't been changed.

The system 1 maintains “master” VMF database 20 of all suppliers on-boarded to the system 1. Further, VMF's for each particular customer (with their particular supplier's information) may be downloaded to customer systems 5 (applications may be provided on the customer systems 5 which are compatible with the system 1) or customer VMFs may be maintained by the vendor system 1 which can be accessed directly by the customers.

The next time a supplier is requested to on-board for another customer, they will only need to enter items that they haven't previously been asked for by other customers, thus saving them significant time in providing details to new customers. Much of their information may also have already been verified, three-way checked, etc.

Customers and suppliers registered with the system 1 may communicate with each other via comms 18 (FIG. 1), which can include any form of messaging, email, etc. Customers may therefore use the system 1 as their portal to interact with suppliers. There is also the option of using the system 1 for all transactions with suppliers, including payments, for example. The System therefore provides a unique global mechanism for all Customers and their Suppliers to efficiently communicate in a secure, organised, trackable, auditable mechanism eliminating duplication.

The supplier search engine and “feeds” 15 enable customers to search for new suppliers that they may wish to on-board for various products/services. This therefore provides an excellent marketing platform for suppliers.

A supplier may upload information directly to customers via the system 1, by way of “feeds” 15. The supplier may wish to update various details and information and they can do this via regular feeds. They can also advertise and provide information e.g. “stock levels” over the platform via the feeds.

The maintenance engine and processes 16 may monitor “feeds” to update suppliers' details in the VMF 20. The maintenance engine and processes 16 may also be configured to carry out their own automated checks to determine that supplier's information is maintained. For example, they may access external systems such as the ABR registry on a regular basis to detect changes that may have occurred to the supplier's information. It may e.g. detect that a Supplier is no longer trading and alert Customers to this fact.

The system 1 also supports a rating engine and processes 17. Customers can apply ratings to various suppliers. This can assist in customers selecting suppliers.

The rating engine 17 may also automatically implement algorithms and checks to apply ratings to suppliers. For example, if transactions are taking place via the system, these can be monitored by the rating engine to determine effectiveness of suppliers.

For example the system can automatically track (subject to “opt in”) and rate suppliers and customers by:
Responsiveness to initiated queries by customers of suppliers and vice versa
Customer responsiveness to invoices and when payments are made
The value and frequency of payments customers make to their suppliers
How many suppliers a customer makes payments to
How many customers a supplier receives payments from
How long a customer or a supplier has been in business (based on ABN).
Other rating parameters may be applied.

In an embodiment, the system also implements additional business email compromise (BEC) protection.

BEC occurs when a senior staff member of Customer or their Supplier's email is compromised. Typically the person (or software) monitors the email account and waits for an opportune time to send an email to the Customer asking them to make a payment or change some payment details on their system. This is often inserted in the middle of an ongoing trail of email communications between the supplier and the customer so it is very hard for the Customer to detect that this particular part of the email is fraudulent whilst all the rest of the email chain/trail is legitimate. It is a major fraud attack vector and very hard to combat. The reason is that email is typically not very secure and it is generally very easy to access target email accounts because of “weak passwords”, the use of email on numerous devices including mobile devices used on insecure “Wi-Fi hotspots”, lost/stolen phones/laptops/tablets etc. Furthermore sometimes these attacks don't even access the email account but simply “spoof” them pretending to be from the trusted supplier etc.

As a result, relying on email communication for transmitting of information containing payment and other sensitive details e.g. invoices, statements etc., whilst widespread, is very dangerous.

With the system of this embodiment, all such communication can be done through the system. The system is (unlike email), secure and independently verifies any new or changed details making it able to be relied on. All changes are audit tracked and can be reviewed by the customer. Essentially it could be used as an Invoice-delivery/authentication system too i.e. suppliers could upload (or later deliver directly from their accounts system) the invoice and we would verify and sign them as legitimate for customers to then download.

The Auditable information logging and account data could in an embodiment be implemented using “distributed ledger” technology such as “Blockchain” to further ensure its accuracy and security.

To further ensure security, in an embodiment, the system implements a 2 factor check to ensure that even if someone is able to access the system they will need a One Time Password prior to being able to submit any new or changed data to the customer. I.e. they will be sent a one-time password (OTP) via SMS to the originally registered phone number verbally initially provided to the customer. This OTP has to be entered into the submission form and all data verified either electronically or through the verification team prior to the system making the data available to the Customer. (SMS is just one embodiment—could be a hardware token, or software second factor program like Google™ authenticator.)

A further advantage of this embodiment is that the system is “auto/self-correcting”. IE if a supplier changes their bank but forgets to tell all their customers, if just one of their customers that has been told, uses the system, the system will flag to the other customers that the details have changed (even if the supplier never told these customers). The system is therefore a self-correcting system. It effectively uses the community to provide ongoing continuous updates and the system constantly rebalances and dynamically resolves conflicts between the data.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A system, comprising:
a database storing data received from suppliers, wherein the data is stored in a plurality of database fields, a management platform implemented on one or more processors, memory, and an operating system supporting computer processes including:
a customer interface process;
a customer form engine;
an information management engine;
an authentication engine;
a supplier interface process; and
a maintenance engine; wherein
the customer interface process executes on the management platform and is configured to access the customer form engine, which customer form engine is arranged to enable selection or creation of database fields and/or form fields designating data required by a particular customer, and generate a customer interface arranged to be displayable from a display device of one of a plurality of customer computing systems, to enable input, via the customer interface, of a request for onboarding of one or more suppliers to the management platform, the request comprising input data in relation to requested information for the one or more suppliers, wherein the input data in respect of each supplier comprises a selection or input of one or more supplier onboarding request form fields via the customer form engine, the customer interface process, in response to receiving the input data, generates by the customer form engine for each supplier, a data object being a supplier request form data object comprising data fields corresponding to the one or more supplier onboarding request form fields input or selected via the customer interface;
the information management engine executed on the management platform and is arranged to, in response to the generation of the supplier request form data object by the customer form engine in the customer interface process, access the database to populate one or more data fields of the supplier request form data object for a particular supplier with any available data of the particular supplier from one or more database fields from the database which correspond with the supplier onboarding request form fields, or with further information relating to the particular supplier obtained by the information management engine using the authentication engine;
wherein the customer interface process being further configured to generate display signals based on the populated supplier request form data object, for display of a supplier request form on the customer interface, and enable input of an approval of the populated supplier request form via the customer interface, and,
wherein in response to receiving approval via the customer interface for a supplier request form in respect of a supplier being approved for presentation to the supplier, by a customer requesting onboarding of the supplier, the management platform transmits a communication to a supplier computing system of the supplier, the supplier computing system including a display apparatus, the communication comprising an access link to enable access to the form by the supplier computing system, via the supplier interface process;
the supplier interface process being arranged to, in response to a supplier accessing the access link to the supplier interface, generate display signals based on data fields of the approved supplier request form data object to display a request form on the supplier interface viewable from a display device of the supplier computing system, the supplier interface process further being arranged to enable the supplier to, from its supplier computing system, provide input data corresponding to form object data fields not already populated by the information management engine;
the authentication engine arranged to, in response to the management platform receiving supplier input data from a supplier computing system of a particular supplier who provided input data in completing a request form displaying data of a request form object in respect of the particular supplier, the authentication engine cross referencing the supplier input data with any available data stored in the database relating the particular supplier provided by multiple customers of the particular supplier, to thereby improve the accuracy of the data of the particular supplier, and the authentication engine accessing third party systems to obtain further data of the particular supplier and/or to check the veracity of the supplier input data of the particular supplier, wherein the authentication engine applies fuzzy logic to information stored in the database, to avoid false positive mismatches between the stored information and the data obtained from the supplier interface process; and
the maintenance engine is arranged to implement maintenance processes for maintaining currency of the data of the particular supplier, wherein the maintenance engine is arranged to interface with the third party systems to periodically check for changes to the data of the particular supplier.

2. The system of claim 1, wherein the authentication engine executes a financial authentication process arranged to access a financial institution system to obtain financial data.

3. The system of claim 1, wherein the authentication engine executes a company information process which is arranged to access one or more business register systems to obtain company business information.

4. The system of claim 1, wherein the authentication engine is arranged to cross-reference the further information obtained from different third party systems to confirm the veracity of the further information.

5. The system of claim 4, wherein the authentication engine is arranged to implement algorithms to analyse discrepancies and similarities of the data to confirm the veracity of the data.

6. The system of claim 1, further comprising a rating engine arranged to automatically facilitate application of ratings to suppliers.

7. The system of claim 6, wherein the rating engine is arranged to monitor transactions and/or payments by customers to the particular supplier via the system and use the transaction data obtained in applying a rating to the particular supplier.

8. The system of claim 1, wherein the information management engine is arranged to access the database to obtain the data or cross-check the data.

9. The system of claim 1, arranged to provide vendor data master files (VMF) for each customer, including data associated with the customer's suppliers.

10. A computer implemented method, comprising:
receiving, by a management platform, via a customer interface, from each of a plurality of customer computing systems, input data in relation to requested information for one or more suppliers, for on-boarding of one or more suppliers, wherein the input data in respect of each supplier comprises a selection or input or creation of one or more supplier onboarding request form fields;
responsive to receiving the input data in relation to requested information for a particular supplier from a customer computing system via the customer interface, the management platform generating, using a form engine, a form object in respect of the supplier, the form object comprising data fields corresponding to one or more supplier onboarding request form fields for the supplier;
automatically populating by the management platform one or more of the data fields of the form object for the particular supplier with any available data of the particular supplier from one or more database fields in a database of the management platform, wherein the database fields correspond with the supplier onboarding request form fields, or with further information relating to the particular supplier, the management platform being configured to generate display signals for display of a request form based on the populated form object, on the customer interface, for viewing on a display device of the customer computing system, the management platform being further configured to enable input of an approval of the displayed request form via the customer interface;
in response to the receiving an input via the customer interface indicating approval of the request form for presentation to the supplier whose information is being requested, transmitting by the management platform a communication to a supplier computing system of the supplier with an access link to a supplier interface;
in response to the supplier accessing the access link from the supplier's computing system, generate display signals to display in a supplier interface the request form in accordance the approved form object, for viewing on a display device on the supplier's computing system,
enabling the supplier to, via the supplier interface, input data from the supplier computing system of the particular supplier, provide input data corresponding to form object data fields not already populated;
obtaining, by an authentication engine of the management platform, further data of the particular supplier from one or more third party systems;
in response to receiving supplier input data from the supplier system via the supplier interface, the authentication engine authenticating the data, comprising cross referencing the supplier input data with any available data in relation to the particular supplier provided by at least one other customer system, or with the further data, to check the veracity and/or improve the accuracy of the supplier input data; wherein the data in the database of the management platform have applied thereto a fuzzy logic, to avoid false positive mismatches between the supplier input data from the particular supplier, the further data from third party systems, and the data provided by at least one other customer system;
storing by the management platform supplier input data as authenticated in the database of the management platform; and
maintaining by the management platform the currency of data in the database, via a maintenance engine of the management platform, wherein the maintenance engine is arranged to interface with third party systems to periodically check for changes to data.

11. The method of claim 10, wherein the authentication step comprises accessing third party systems to obtain the further data and/or to check the veracity of the data.

12. The method of claim 11, wherein the authentication step comprises accessing a financial institution system to obtain financial data.

13. The method of claim 11, the authentication step comprising accessing one or more business register systems to obtain company business information.

14. The method of claim 10, comprising the further step of cross referencing further data obtained from different third party systems to confirm the veracity of the further data.

15. The method of claim 10, comprising the step of algorithmically analysing discrepancies and similarities of further data to confirm the veracity of the data.

16. The method of claim 10, comprising the step of monitoring transactions and/or payments between customers and suppliers via the system and applying a rating to the particular supplier based on the transactions and/or payments.

17. A non-transitory computer readable medium, providing a computer program which comprises instructions for controlling a computer to implement a system in accordance with claim 1.

18. The system of claim 1, wherein
the supplier interface process is further arranged to, in response to a supplier accessing the access link to the supplier interface, request the supplier computing system to transmit an authentication input; and
the authentication engine is further arranged to, in response to receiving supplier input data and the authentication input from the supplier computing system, verify the authentication input by determining if it is a predetermined value, and only accept the supplier input data in response to verification of the authentication input.
